(19) United States
(12) Patent Application Publication
(10) Pub. No.: US 2025/0058767 A1
(43) Pub. Date: Feb. 20, 2025

(54) METHOD FOR DETERMINING A MAXIMUM COEFFICIENT OF FRICTION OF A WHEEL OF A VEHICLE ON A ROAD

(71) Applicant: ZF CV Systems Global GmbH, Bern (CH)

(72) Inventor: Adarsh Venkata Padmanabhan, Pattensen (DE)

(21) Appl. No.: 18/937,831

(22) Filed: Nov. 5, 2024

Related U.S. Application Data
(63) Continuation of application No. PCT/EP2023/055288, filed on Mar. 2, 2023.

(30) Foreign Application Priority Data
May 5, 2022 (DE) 10 2022 111 202.0

(51) Int. Cl. B60W 30/02; B60W 10/04; B60W 10/18

(52) U.S. Cl. CPC B60W 30/02; B60W 10/04; B60W 10/18; B60W 2520/06; B60W 2520/14; B60W 2520/26; B60W 2520/28

(57) ABSTRACT

A method is for determining a maximum coefficient of friction of a wheel of a vehicle on a road. The method includes: determining a reference wheel acceleration of the wheel, wherein accelerations and a yaw behavior of the wheel and/or of the vehicle on the road are determined, determining a real wheel acceleration of the wheel, wherein a slip behavior of the wheel on the road is determined, comparing the reference wheel acceleration and the real wheel acceleration, in particular forming a quotient, determining the maximum coefficient of friction from the comparison of the reference wheel acceleration and the real wheel acceleration.

### CROSS-REFERENCE TO RELATED APPLICATIONS

This application is a continuation application of international patent application PCT/EP2023/055288, filed Mar. 2, 2023, designating the United States and claiming priority from German application 10 2022 111 202.0, filed May 5, 2022, and the entire content of both applications is incorporated herein by reference.

### TECHNICAL FIELD

The disclosure relates to a method for determining a maximum coefficient of friction of a wheel of a vehicle on a road, a control unit and a vehicle.

The coefficient of friction or coefficient of adhesion or friction value between a vehicle wheel and the road is taken into account in various vehicle control systems, in particular vehicle control systems and driver assistance systems.

In principle, the current or actual coefficient of friction of the driving situation and the maximum coefficient of friction are relevant here. The exact value of the coefficient of friction depends on the materials of the two surfaces, that is, the road surface and the surface of the vehicle tire, as well as on current, changing variables, such as temperature, humidity, the roughness of the surfaces and the influence of additional particles such as sand, grit or dirt. An exact knowledge of the coefficient of friction is therefore important, but often difficult to estimate.

DE 10 2016 211 728 A1 describes a method for determining the coefficient of friction in which a first wheel of a vehicle is braked in such a way that slip occurs between the first wheel and a road that is smaller than the slip between a second wheel and the road, wherein the behavior of the first wheel during braking is determined. Thus, a coefficient of friction is determined from a comparison of the slip behavior of several wheels of the vehicle. For this purpose, comparable coefficients of friction on the wheels are first assumed, wherein an active braking process is envisaged for the determination.

DE 10 2020 111 520 B3 describes a method for determining the coefficient of friction in which a wheel load on a vehicle wheel is reduced and the track angles of wheels on an axle are specifically adjusted, so that a preliminary friction value is first deter-mined, wherein a longitudinal wheel force and a normally applied wheel load are then used for further calculation. For such a determination, active adjustments are made to the vehicle or wheels and wheels of an axle are compared with each other.

Such methods generally make it possible to determine the actual coefficients of friction of the driving situation at hand. However, the determination of the maximum co-efficient of friction or peak coefficient of friction is still helpful, especially for driving stability control systems and braking systems.

### SUMMARY

It is an object of the disclosure to provide a method for determining a maximum coefficient of friction, a control unit for carrying out the method and a vehicle that enable an accurate determination of the maximum coefficient of friction with relatively little effort.

This object is, for example, achieved by a method for determining a maximum coefficient of friction of a wheel of a vehicle on a road. The method includes: determining a reference wheel acceleration of the wheel, wherein accelerations and a yaw behavior of at least one of the vehicle and the wheel on the road are determined; determining a real wheel acceleration of the wheel, wherein a slip behavior of the wheel on a road surface is determined; comparing the reference wheel acceleration and the real wheel acceleration; and, determining the maximum coefficient of friction from the comparing the reference wheel acceleration and the real wheel acceleration.

Furthermore a vehicle control method using the method, a control unit for carrying out the method and a vehicle with the control unit are envisaged.

Thus, it is envisaged to calculate the maximum coefficient of friction between a wheel and the road from a comparison of a reference wheel acceleration, which is determined on the basis of the behavior of the vehicle, and a real wheel acceleration, which is determined from the slip behavior of the wheel.

This already achieves some advantages:
the determination of the maximum coefficient of friction can be carried out in principle with existing sensors in the vehicle. In this context, it is advantageous to use information already available for other control systems and regulating systems, for example information and data about the acceleration behavior and yaw behavior of the vehicle in the plane, which is either already available for other control systems or can be determined with little effort. For example, the determination of the real wheel acceleration of the wheel using wheel slip in particular is generally possible with little effort, since the slip behavior is generally already determined for different control and regulation systems in the vehicle, in particular ABS.

A further advantage of embodiments of the disclosure is that a determination is basically possible without actively influencing the vehicle, in particular also without active braking or acceleration processes. This means that there is no need for test braking and other processes that can affect the stability of the vehicle and driving behavior, and that are also more time-consuming and cannot be carried out continuously.

Another advantage of embodiments of the disclosure is the reproducibility of the determinations and measurements. For example, estimates of a coefficient of friction due to active adjustments are generally not as reproducible as a determination based on already available sensor data. Furthermore, an individual determination of the coefficients of friction for each vehicle wheel with conventional methods is generally more complex, especially with active adjustments.

A further advantage of embodiments of the disclosure is that the determination of the maximum coefficient of friction can in principle be carried out independently of measurements or estimates of the surface quality.

The disclosure is based on the knowledge that the maximum coefficient of friction exerts a different degree of influence on real wheel acceleration behavior of the vehicle wheel, in particular slip behavior, and reference wheel acceleration behavior of the wheel in the vehicle. In particular, a reference acceleration of the wheel can be determined as a value dependent on the maximum coefficient of friction and a real wheel acceleration as a value independent of the maximum coefficient of friction or normalized, so that the maximum coefficient of friction, in particular of each individual wheel, can be determined from a comparison of these variables, in particular from a quotient.

According to an embodiment, the reference wheel acceleration is determined from measured acceleration values and a measured yaw behavior of the vehicle, in particular a yaw rate. The measurements can be carried out in particular via inertial sensors. It is advantageously used that suitable sensors, especially inertial sensors, can already be provided for other control systems.

In the calculation, the distances of the wheel from the sensors and/or from a center of gravity of the vehicle are advantageously included in the calculation. Thus, a quick up-to-date determination can be carried out using fixed geometric distances that do not change over time. In particular, a uniform sensor distance of an inertial measurement unit (IMU) can be used here. According to an alternative configuration, the maximum coefficient of friction is estimated on the basis of a simple variation model using a two-point difference approach.

Thus, the acceleration of the vehicle in the plane, that is, in the longitudinal and lateral directions, as well as the yaw behavior can be measured by a sensor unit, and the respective acceleration behavior of the vehicle wheel in the plane, that is, the longitudinal acceleration and lateral acceleration of the wheel in a coordinate system of the wheel, can be determined from the distance of the respective vehicle wheel from the sensor unit.

When determining the reference wheel acceleration, a vertical component of the measured values of the accelerations and the yaw behavior is preferably compensated or subtracted in order to obtain the dynamics in the plane. In particular, gravity-compensated accelerations in the longitudinal and transverse direction are determined, as the movement behavior in the plane of the road is to be taken into account. Thus, in particular, a driving situation with a vertical component, for example on an upslope or descent, on a road with a transverse inclination, preferably also due to a shaking movement or rolling movement of the vehicle around its longitudinal axis or a pitching movement around its transverse axis, should also be taken into account.

As an alternative to or in addition to measurements, it is also possible to determine the accelerations and yaw behavior from data about the position of the vehicle in an external positioning system, for example a GPS, by using the trajectory of the vehicle in the external positioning system.

The real wheel acceleration is advantageously calculated from a longitudinal slip and a transverse slip of the wheel, wherein these slip values are in turn determined from other vehicle variables. In particular, the transverse slip can be determined from the wheel revolution rate, a steering angle of the wheel and the measured yaw rate, in particular by using geometric values of the vehicle, for example the track width of the axle in question, in order to determine the position of the wheel. This makes it easy to determine the transverse slip with existing or easy-to-determine values.

The longitudinal slip of the wheel is generally already used for control systems such as ABS and/or ASR and is therefore often known; it can be determined in particular from the wheel revolution rate, a steering angle of the wheel, the yaw rate, in particular by taking into account other values such as the geometric configuration of the vehicle, in particular the track width, and vehicle data of the vehicle such as the direction of travel and the vehicle speed.

The different coordinate systems of the vehicle and the vehicle wheel can be converted into each other by transforming the vehicle coordinates or the measured variables to one of the two coordinate systems. This conversion can be advantageously carried out using constant values, in particular geometric values of the vehicle and/or the wheel, so that a quick and uniform conversion is possible, in which the same variables are included in each case, so that no current measurement errors add up.

The method according to the disclosure can be used in particular on a commercial vehicle, in particular with two or more non-lifted axles. It is in principle not limited to a certain number of axes.

This advantageously enables an up-to-date and fast determination of the maximum coefficients of friction for individual wheels, especially for the wheels of all non-lifted axles of the vehicle. The maximum coefficients of friction determined in this way enable control and regulation systems as well as control and regulation methods of the vehicle, in particular brake control systems, to be implemented quickly and in a targeted manner.

The control and regulation systems can preferably also include the actual or current coefficient of friction, which is determined by a conventional method, for example one of the methods described above.

According to advantageous embodiments, one or more of the following intermediate steps are envisaged:
conversions between a road coordination system, a vehicle coordination system and a wheel coordination system,
a transformation of vehicle speeds from a road coordination system to a wheel coordinate system,
a conversion of the longitudinal wheel speed of a steerable front axle using the transformed wheel coordinates,
a determination of the wheel slip of the steerable front axle,
a determination of the longitudinal slip and the transverse slip of the front axle,
a calculation of the lateral wheel speeds (transverse speeds) of the wheels of the steerable front axle, a calculation of the transverse vehicle speed from the determined transverse speed of the front axle,
a determination of the coordinates of the wheels or axles in a vehicle coordinate system, in particular relative to the center of gravity,
a calculation of the transformed wheel reference speeds of the other axles, a calculation of the longitudinal slip and transverse slip of the wheel axles.

According to an embodiment, it is envisaged that in the case of a low steering angle, that is, in particular below a steering angle limit, in particular in the case of non-steered axles or in the case of a steered axle in a straight line or close to a straight line, a longitudinal slip and a transverse slip of a wheel are calculated via a projection difference between the projections of the longitudinal slip and the transverse slip onto a longitudinal direction of the wheel. This results in a simple and reliable determination of both slip values without including variables that may not be available.

### BRIEF DESCRIPTION OF DRAWINGS

The invention will now be described with reference to the drawings wherein:

FIG. 1 shows a vehicle model of a vehicle with five axles on a road;

FIG. 2 shows a representation of the center of gravity offset of the sensor unit;

FIG. 3 shows a representation of the forces and the acceleration on a vehicle wheel;

FIG. 4 shows a representation of the reference systems on a vehicle wheel;

FIG. 5 shows a flow diagram of a method according to the disclosure; and,

FIG. 6 shows a representation of the determination of a projection difference.

### DETAILED DESCRIPTION

A commercial vehicle 1 with five axles A1, A2, A3, A4 and A5 is driving on a road 2 with a road surface 3. The individual wheels 4 of the commercial vehicle 1 have a tire surface 6 and a wheel axle 7, wherein the tire surface 6 is resting on the road surface 3 in a tire contact area 8. Between the tire surface 6, which is generally made of rubber material, and the road surface 3, a static friction or rolling friction is formed, which can be described by a current or actual coefficient of friction or coefficient of static friction and a maximum coefficient of friction (maximum coefficient of static friction) mue_0. The actual coefficient of friction and the maximum coefficient of friction mue_0 depend on various current conditions and properties of the tire surface 6 and the road surface 3 that are not known in advance, in particular on the materials or material compositions, temperatures, roughness, and moisture or degree of humidity and particles such as sand or grit lying on the road surface 3. Thus, a coefficient of friction mue is formed, the maximum value of which mue_0 is relevant for the behavior of the commercial vehicle 1 on the road 2.

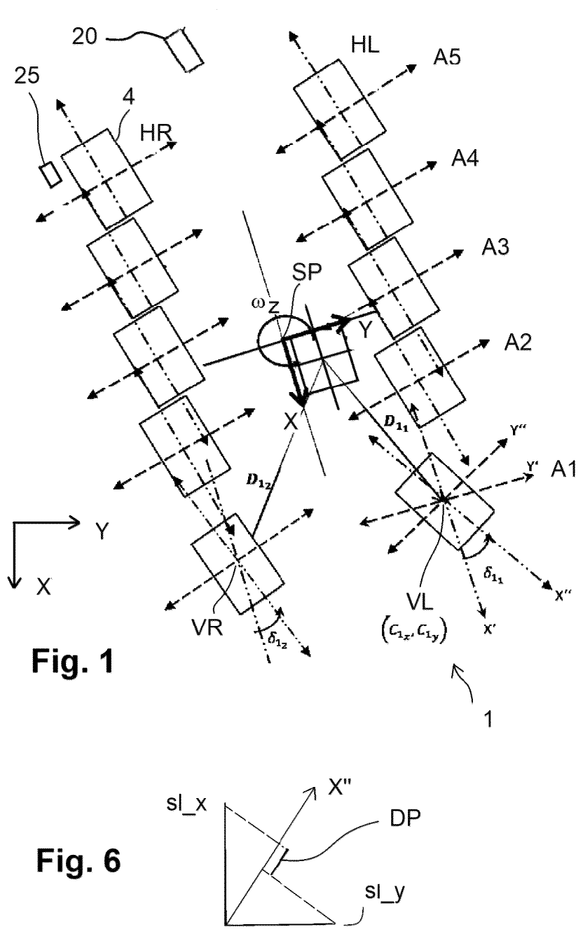

Different coordinate systems are drawn in FIGS. 1 to 4. As is usual, a road coordinate system with the coordinates XYZ is used, which is thus related to the road 2, wherein the vertical direction Z is initially not relevant for these plan views and calculations and subsequently sensor values in the vertical Z direction are compensated or corrected accordingly. Furthermore, a vehicle coordinate system with the coordinates X′Y′Z′, which is also called the axle coordinate system, and a wheel coordinate system with the coordinates X″Y″Z″ are envisaged.

As is usual, the individual wheels 4 of the commercial vehicle 1 are denoted by indices i for the axle and j for the side of vehicle 1, with j=1 for the left side and j=2 for the right side. Thus, the respective physical quantities of the wheels 4 are also denoted by these indices i and j. FIG. 1 thus shows the commercial vehicle 1 in a top view, with a front axle A1 and other axles A2 to A5, so that the rear axle is designated as A5. The steered front axle A1 is thus formed by the left front wheel VL, which bears the indexation i=1, j=1, and a right front wheel VR, which bears the indexation i=1, j=2. Accordingly, the left rear wheel HL is described by the indexing i=5 (5th axis) and j=1, and the right rear wheel HR with the indexing i=5, j=2.

The steering angle delta is denoted by delta_ij for a wheel 4-ij.

In the description of the embodiments, indexes relating to all values of the indices have been omitted in some cases; for example, sl_x or slx is generally used for slij_x, that is, in particular for all values i and j or all relevant values of i and j: accordingly, sl_y or sly is generally used for slij_y, that is, in particular for all values i and j or all relevant values of i and j.

Furthermore, mathematical reference signs and variables, which are generally denoted by Greek letters such as μ, δ, α, ω, σ, are also represented in the usual way by their transcriptions in Latin letters, that is, for example as mue, delta, alpha, omega, sigma.

In the commercial vehicle 1, the front axle A1 is steered, that is, the front wheels VL and VR are adjustable in relation to the vehicle coordination system X′ Y′. The other four axles A2 to A4 cannot be lifted, that is, they remain in the tire contact area 8 with the wheel load on the road 2.

The physical variables are still related to the respective coordinate systems, so that they carry the indexing of the coordinate systems XYZ, X′Y′Z′ and X″Y″Z″. The coordinate systems XYZ, X′Y′Z′ and X″Y″Z″ can be converted into each other accordingly, as can be seen from FIG. 4 and the following equations. A transformation of the coordinate systems generally takes place as a linear transformation via matrices, in the case of observations in the plane thus via 2×2 matrices. The distances between the zero points of the coordinate systems and their alignment with each other must be taken into account

The vehicle 1 has a center of gravity SP and an inertial measurement unit (IMU) 10 with an accelerometer 11 for measuring a longitudinal acceleration a′x in the longitudinal direction X′ and a lateral acceleration a′y in the transverse direction Y′, furthermore a yaw rate sensor 12 for measuring a yaw rate omega around the vertical axis or yaw axis running in the vertical Z′ direction, that is, in the X′X′ plane.

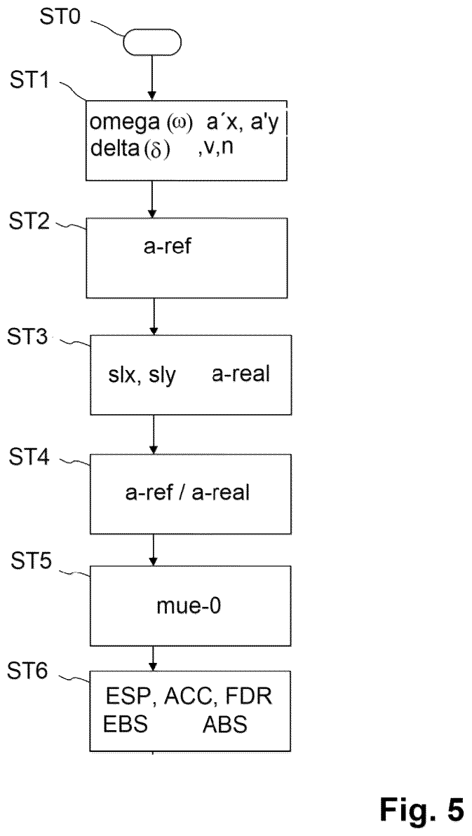

According to the method in FIG. 5, after the start in step ST0, measured values of the inertial sensor device 10 and other vehicle variables of the vehicle 1 are recorded in step ST1, in particular the vehicle longitudinal acceleration a′x and the vehicle lateral acceleration a′y, the driving speed v and the wheel speeds n. Furthermore, a steering angle delta of the individual wheels, that is, especially the front wheels VL and VR, is measured or determined.

Steps ST2 to ST5 are carried out below for each wheel 4, that is, the wheels 4-ij with i=1 to 5 and j=1 and j=2.

In step ST2, a reference wheel acceleration a-ref of the wheel 4 in the vehicle coordinate system X′Y′ is determined via, among other things, the longitudinal acceleration a′x in the longitudinal direction X′ and the lateral acceleration a′y in the transverse direction Y′ as well as the yaw rate omega. The steering angle delta of the wheel 4 or the wheel longitudinal axis X″ relative to the direction of travel X′ and a distance SD of the wheel 4 from the zero point of the coordinate system X′Y′, that is, generally the position of the inertial sensor unit 10 of vehicle 1, is to be taken into account here.

In step ST3, the real wheel acceleration a-real of the wheel 4 on the road 2 is determined on the basis of a longitudinal slip sl_x and a transverse slip sl_y. Steps ST2 and ST3 can be performed in any order or in parallel.

In step ST4, a comparison of the reference wheel acceleration a-ref and the real wheel acceleration a-real is made, in particular by forming a quotient,
so that the maximum coefficient of friction mue_0 is determined in step St5.

In the following, the conversion of the wheel speeds vij from the road coordinate system XY to the wheel coordinate system X″Y″ is described as an example of the conversions of the coordinate systems, with the components Vx-direction in the x-direction and Vy-direction in the y-direction.

A linear transformation is carried out according to equation

$${[ \begin{matrix}{V}_{{i}_{{j}_{x}}} \\ {V}_{{i}_{{j}_{y}}}\end{matrix} ]}_{{X}^{″} {Y}^{″}} = {R ( {δ}_{{i}_{j}} ) [ \begin{matrix}{V}_{{x}_{B}} \\ {V}_{{y}_{B}}\end{matrix} ]}_{{X}^{′} {Y}^{′}} = [ \begin{matrix}cos {δ}_{{i}_{j}} & sin {δ}_{{i}_{j}} \\ - sin {δ}_{{i}_{j}} & cos {δ}_{{i}_{j}}\end{matrix} ] [ \begin{matrix}{V}_{x} σ - {C}_{{i}_{y}} {ω}_{z} \\ {V}_{y} + {C}_{{i}_{x}} {ω}_{z}\end{matrix} ] \qquad Equation ( GL 1 )$$

with the variables
Cix, Ciy X, Y-coordinates of the wheel j on the axle i
wherein C2x=C1x−I12, C3x=C1x−I13, et cetera, wherein
C1x is the X component of the steerable front axle A1 in meters,
C2x is the X component of the second axle A2 in meters, et cetera,
I1i is the axle distance between axle 1 and axle i
Vx, Vy are the X and Y components of the vehicle speed V at the position of the inertial sensor unit 10,

Here, δij specifies the steering angle or control angle of the wheel j on the axle i in radians, in the wheel coordinate system X″Y″, and is therefore used to convert from the wheel coordinate system X″Y″ to the vehicle coordinate system X′Y′
Vijx and Vijy as x-component and y-component of the speeds of the wheel 4-ij,
the wheel 4-11 is thus the wheel VL, the wheel 4-12 is thus VR, 4-21 is HL, 4-22 is VR, in the wheel coordinate system X″Y″
bi as the track width of the axle l,
dx dy as the sensor distance between the center of gravity SP and the inertial sensor unit 10,
R (delta_ij) as a rotation matrix around the steering angle delta_ij
σ (sigma) represents a signum or sign value, with sigma as +1, 0, −1 of the direction of travel, that is, forward travel, standstill or reversing.

The transformation with the velocity vector on the right side of the equation, that is,

$$[ \begin{matrix}{V}_{x} σ - {C}_{{i}_{y}} {ω}_{z} \\ {V}_{y} + {C}_{{i}_{x}} {ω}_{z}\end{matrix} ]$$

is basically not necessary; a determination is possible in the coordinate system X′Y′ or X″ Y″, since this calculation of equation GL1 is used to determine the reference wheel acceleration, which is ultimately always viewed in the vehicle coordinate system X′Y′.

The calculation of the longitudinal wheel sped of the steerable front axle VL is described below using the transformed wheel speeds:

The determination of the wheel slip sl for the non-liftable wheels 4_ij is preferably carried out with the equation GL-sl-v

$${[ \begin{matrix}sl - ijx \\ sl - ijy\end{matrix} ]}_{{X}^{″} {Y}^{″}} = [ \begin{matrix}\frac{{v}_{{i}_{j}} σ - {v}_{{i}_{jx}}}{max ( \vert {v}_{{i}_{j}} \vert , \vert {v}_{{i}_{jx}} \vert )} \\ - ( \frac{{v}_{{i}_{{j}_{y}}}}{max ( \vert {v}_{{i}_{j}} \vert , \vert {v}_{{i}_{jx}} \vert )} )\end{matrix} ] \qquad ( GL - sl - v )$$

wherein
sl-ijx is the wheel slip in the direction of rotation of the wheel 4-ij,
sl-ijy is the wheel slip perpendicular to the direction of rotation of the wheel 4-ij,
Vij is the value of the wheel speed of the wheel j on the axle i, expressed in m/s, wherein this value is preferably obtained from the wheel speed sensor and/or the wheel revolution rate n,
sigma is the direction of travel of the vehicle 1,
that is, sigma=1 for forward travel, sigma=0 for standstill and sigma=−1 for reversing.

The calculation of the combined wheel slip of the steerable front axle VL is then preferably carried out as follows:

The first component or first vector element of GI-sl-v is used as

$$sl - ijx = \frac{{v}_{{i}_{j}} σ - {v}_{{i}_{jx}}}{max ( \vert {v}_{{i}_{j}} \vert , \vert {v}_{{i}_{jx}} \vert )} \qquad ( GL - sl - v - x )$$

using GL-vijx:

$$V 1 jx = ( Vx σ - C 1 y ω z ) sec δ 1 j + V 1 j y tan δ 1 j \qquad ( GL - vijx )$$

results in GL-sl-v-delta

$$( GL - sl - v - delta )$$

$$sl 1 jx = ( V 1 j σ - ( ( Vx σ - C 1 y ω z ) sec δ 1 j + V 1 jy tan δ 1 j ) / max ( \vert V 1 j \vert , \vert ( Vx σ - C 1 y ω z ) sec δ 1 j + V 1 jy tan δ 1 j \vert )$$

and from this

$$\text{?} = \frac{\text{?} - ( ( \text{?} - \text{?} ) \text{?} )}{max ( \vert \text{?} \vert \text{?} \vert ( \text{?} - \text{?} ) \text{?} + \text{?} \vert )} - \frac{( \text{?} )}{max ( \vert \text{?} \vert \text{?} \vert ( \text{?} - \text{?} ) \text{?} + \text{?} \vert )}$$

$$\text{?} + \frac{( \text{?} )}{max ( \vert \text{?} \vert \text{?} \vert ( \text{?} - \text{?} ) \text{?} + \text{?} \vert )} - \frac{\text{?} - ( ( \text{?} - \text{?} ) \text{?} )}{max ( \vert \text{?} \vert \text{?} \vert ( \text{?} - \text{?} ) \text{?} + \text{?} \vert )}$$

$$\text{?} \text{indicates text missing or illegible when filed}$$

From the second component or the second vector element of Gl-sl-v, the following combined slip equation GL-sl-komb is derived

$$( GL - sl - komb )$$

$${sl}_{{1}_{jx}} - {sl}_{{1}_{{j}_{y}}} tan {δ}_{{1}_{j}} = \frac{{V}_{{i}_{j}} σ - ( ( {V}_{x} σ - \text{?} ) sec {δ}_{{1}_{j}} )}{max ( \vert \text{?} \vert \text{?} \vert ( \text{?} - \text{?} ) sec {δ}_{{1}_{j}} + \text{?} tan {δ}_{{1}_{j}} \vert )}$$

$$\text{?} \text{indicates text missing or illegible when filed}$$

Thus, GL-sl-komb can be simplified with known values of the driving speed vx and v1j, with the known direction of travel sigma, at a low steering angle delta, that is, with non-steered axles or with a steered axle in the area of straight travel, that is, especially with delta <a limit steering angle delta_lim, because then the steering angle delta becomes zero, so that the tangent delta also becomes zero and the term V1ij*tan delta1j as a summand is omitted.

Thus, the longitudinal slip and transverse slip can be calculated at the same time.

The left side of the equation thus describes, as shown in FIG. 6, the difference DP of the projections of the longitudinal slip sl_x and transverse slip sl_y onto the longitudinal direction of the wheel, that is, the X″ axis or the direction in which Y″=0 as shown in FIG. 6.

This representation applies in particular to all relevant values of j and j, so that the indexing of slij_x and slij_y or sl-ijx and sl-ijy in particular is generalized to sl_x and sl_y.

In principle, two approaches are possible here;
If the X-component Vx of the vehicle speed V is sufficiently valid, for example from an ABS reference model, and can therefore be used, the calculation can be carried out directly from the equation GL-sl-komb as described above.

The reference wheel acceleration a-ref and the real wheel acceleration a-real are determined in particular as vector variables in the plane, that is, with x and y coordinates in their respective coordinate system, and are converted or related to each other by transforming the coordinate systems into each other. Here, the maximum coefficient of friction mue_0 is included as a proportionality factor in the relationship between these variables, since the real wheel accelerations a-real determined from the wheel model are determined normalized by this value.

Thus, for each wheel ij, mue_0_ij, that is, the wheel-specific maximum coefficient of friction mue_0 of the wheel ij, is obtained from the following equation GL-mue-a, taking into account the coordinate systems:

$$mue\_ 0 \_ij * ( a - real ) ij = ( a - ref ) ij . \qquad ( GL - mue - a )$$

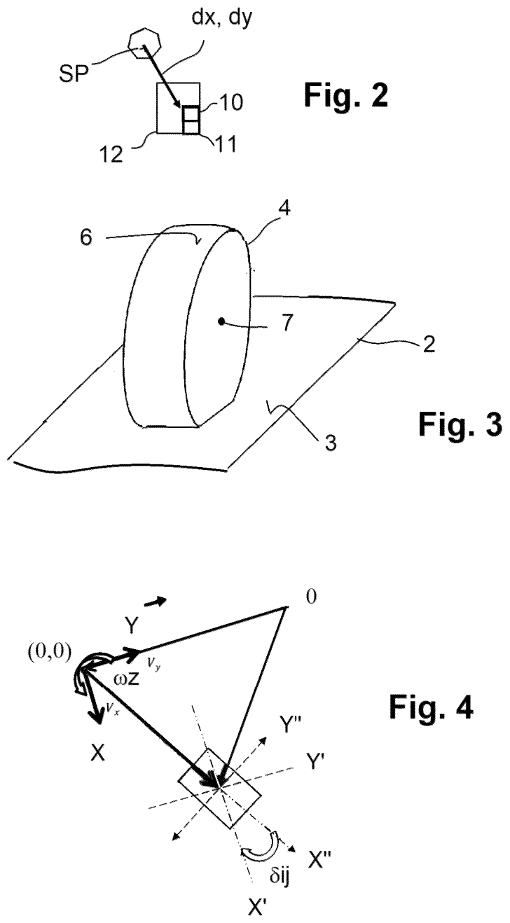

When transforming the coordinate systems, the respective geometric offset dx, dy between the center of gravity SP, which describes the zero point of the vehicle coordinate system X′Y′Z′, and the respective wheel coordinate system X″Y″Z″ must still be taken into account. This is shown in FIG. 2; preferably, however, this center of gravity offset dx, dy can be neglected to a good approximation.

In the calculation, a wheel model is applied according to the following equation GL-TMS (Tire Model Selection):

$$μ ( sl ) = ( a + b + c ) {μ}_{0} {sl}_{0} ( \frac{\text{?}}{\text{?} ( \text{?} ) + b ( \text{?} ) \vert \text{?} \vert + c ( \text{?} )} ) \qquad ( GL - TMS )$$

$$\text{?} \text{indicates text missing or illegible when filed}$$

with mue (sl) as the actual (current) coefficient of friction of the wheel slip, that is, longitudinal and transverse slip,
mue_0 as the maximum coefficient of friction
sl as the wheel slip
sl0 as the wheel slip at the value of the maximum coefficient of friction mue_0
a,b,c as wheel-specific constants.

Instead of the longitudinal and transverse slip, the geometric slip, that is, the geometric sum sl-geom=sqrt ((slx/slx0)²+(sly/sly0)²), can be used,

In the comparison according to step ST4, the following equation GL-PWFC (Peak Wheel Friction Coefficient) is used according to a first embodiment, wherein the Euler angular acceleration can also be taken into account if appropriate:

$$μ ( sl ) = ( a + b + c ) {μ}_{0} {sl}_{0} ( \frac{\text{?}}{\text{?} ( \text{?} ) + b ( \text{?} ) \vert \text{?} \vert + c ( \text{?} )} ) \qquad ( GL - TMS )$$

$$\text{?} \text{indicates text missing or illegible when filed}$$

with
mue (sl) as the actual (current) coefficient of friction of the wheel slip, that is, longitudinal and transverse slip,
mue_0 as the maximum coefficient of friction
sl as the wheel slip
sl0 as the wheel slip at the value of the maximum coefficient of friction mue_0
a,b,c as the wheel-specific constants.

Instead of the longitudinal and transverse slip, the geometric slip, that is, the geometric sum sl-geom=sqrt ((slx/slx0)²+(sly/sly0)²), can be used,

In the comparison according to step ST4, the following equation GL-PWFC (Peak Wheel Friction Coefficient) is used according to a first embodiment, wherein the Euler angular acceleration can also be taken into account if appropriate:

$${{μ}_{{0}_{{i}_{j}}} [ \begin{matrix}{a}_{{i}_{jx}} \\ {a}_{{i}_{jy}}\end{matrix} ]}_{{X}^{′} {Y}^{′}} = [ \begin{matrix}{a}_{{x}_{gComp}} - {ω}_{z}^{2} ( {C}_{{i}_{x}} + {d}_{x} ) \\ {a}_{{y}_{gComp}} - {ω}_{z}^{2} ( {C}_{{i}_{y}} + {d}_{y} )\end{matrix} ] \qquad ( GL - PWF )$$

with:
axgComp, aygComp as gravity-compensated measured values of the longitudinal acceleration ax and the lateral acceleration ay; thus, from the measured values ax and ay of the inertial sensor unit 10, the gravitational force g acting in the vertical direction Z of the road coordinate system XYZ is compensated or corrected, wherein in particular values in the unit m/S2 are applied; thus components az are avoided,
aijx, aijy as wheel longitudinal acceleration and wheel lateral acceleration in the tire contact area 8 in the wheel coordinate system X″Y″, for each sensed wheel 4-ij,
in m/s², that is, the vector mue-0ij*(aijx, aijy) thus corresponds to a-ref, and (aijx, aijy) corresponds to the normalized real wheel acceleration a-real,
Cix, Ciy X, Y-coordinates of the wheel j on the axle i, that is, constants here,
dx, dy as the sensor distance of the inertial sensor unit 10 from the center of gravity SP, which can be calculated in particular in the coordinate system XYZ.

If, on the other hand, the X component Vx of the vehicle speed V is not sufficiently valid, a conversion is carried out using calculated mue_0_ij for time step k and sampling time dT:

$${[ \begin{matrix}{V}_{x} σ - {C}_{{i}_{y}} {ω}_{z} \\ {V}_{y} + {C}_{{i}_{x}} {ω}_{z}\end{matrix} ]}_{k} = {[ \begin{matrix}{V}_{x} σ - {C}_{{i}_{y}} {ω}_{z} \\ {V}_{y} + {C}_{{i}_{x}} {ω}_{z}\end{matrix} ]}_{k 1} + ( {{μ}_{{0}_{{i}_{j}}} [ \begin{matrix}{a}_{{i}_{{j}_{x}}} \\ {a}_{{i}_{{j}_{y}}}\end{matrix} ]}_{{X}^{′} {Y}_{K 1}^{′}} + {[ \begin{matrix}0 & {ω}_{z} \\ - {ω}_{z} & 0\end{matrix} ] [ \begin{matrix}{V}_{x} σ - {C}_{{i}_{y}} {ω}_{z} \\ {V}_{y} + {C}_{{i}_{x}} {ω}_{z}\end{matrix} ]}_{k 1} ) dT$$

where the calculated,

$$[ \begin{matrix}{V}_{x} σ - {C}_{{i}_{y}} {ω}_{z} \\ {V}_{y} + {C}_{{i}_{x}} {ω}_{z}\end{matrix} ]$$

allows a conversion of the reference wheel speed Vij into the wheel coordinate system X″Y″ described coordinate systems according to equation GL_1, and the wheel slip equation according to equation GL-sl-v.

Alternatively, according to a second embodiment, especially if the sensor distance of the sensor unit 10 from the center of gravity SP can be neglected, a two-point finite difference approach is chosen in the comparison after step ST4, with equation GL-F

$${μ}_{{0}_{{i}_{j}}} {Δ [ \begin{matrix}{a}_{{i}_{jx}} \\ {a}_{{i}_{jy}}\end{matrix} ]}_{{X}^{′} {Y}^{′}} = Δ [ \begin{matrix}{a}_{{x}_{gComp}} - {ω}_{z}^{2} ( {C}_{{i}_{x}} + {d}_{x} ) \\ {a}_{{y}_{gComp}} - {ω}_{z}^{2} ( {C}_{{i}_{y}} + {d}_{y} )\end{matrix} ] \qquad ( GL - F )$$

wherein
mue_0-ij is the maximum coefficient of friction of the wheel 4-ij, and
Delta, Δ is the finite difference operator, that is, a mathematical operator.

In this equation, the maximum coefficients of friction mue_0 are independent of the sensor distances, since their influence occurs as a small constant offset and can therefore be neglected to a good approximation.

After step ST5, the determined maximum coefficients of friction mue_0-ij of the wheels 4-ij can be used in a vehicle control system according to step ST6, for example an anti-lock braking control system ABS, traction control system, electronic braking system EBS, vehicle dynamics control system, electronic stability system ESP, driver assistance system, driver comfort system, distance control system, automatic cruise control ACC.

In the vehicle 1, a control unit 20 is provided for one of these vehicle control systems, which thus receives the signals, performs calculations and, for example, controls brakes and/or a drive of the vehicle 1.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle, especially commercial vehicle
2 Road
3 Road surface
4 Wheel
4-ij Wheel of axle i, i=1, 2, 3, 4, 5, with j=1 on the left and j=2 on the right
6 Tire surface
7 Axle
8 Tire contact area
Inertial sensor unit, IMU
11 Accelerometer
12 Yaw rate sensor
20 Control unit of the vehicle 1, in particular of a vehicle control system
25 Wheel brake, in particular controlled by control unit 20
Ai, A1 to A5 Axles of the vehicle 1
A1 Steerable front axle
A5 Rear axle
a-ref Reference wheel acceleration
a-real Wheel acceleration
bi Track width
delta, δ steering angle of the wheel 4 relative to the longitudinal direction X′ of the vehicle 1,
delta-lim Steering angle limit
D Finite difference operator
DP Projection difference of the projections of the longitudinal slip sl_x and the transverse slip sl_y onto a longitudinal direction of the wheel X′
mue-0, μ0 maximum coefficient of friction
mue, μ current coefficient of friction
n wheel revolution rate
omega, ωz Yaw rate of the vehicle 1, that is, around the yaw axis Z
sl_x Longitudinal slip
sl_y Transverse slip
XY Road coordinate system, COG coordinate system
X′Y′ Vehicle coordinate system of the commercial vehicle 1
X″Y″ Wheel coordinate system of a wheel 4
SPB Track width of an axle Ai of the vehicle 1
SD Sensor distance
v Driving speed of the vehicle 1.
XYZ Road coordinate system
X′ Y′ Z′ Vehicle coordinate system
X″Y″Z″ Wheel coordinate system

1. A method for determining a maximum coefficient of friction of a wheel of a vehicle on a road, the method comprising:
determining a reference wheel acceleration of the wheel, wherein accelerations and a yaw behavior of at least one of the vehicle and the wheel on the road are determined;
determining a real wheel acceleration of the wheel, wherein a slip behavior of the wheel on a road surface is determined;
comparing the reference wheel acceleration and the real wheel acceleration; and,
determining the maximum coefficient of friction from said comparing the reference wheel acceleration and the real wheel acceleration.

2. The method of claim 1, wherein a conversion of a wheel speed between a wheel coordinate system and a road coordinate system is carried out via a rotation matrix.

3. The method of claim 1, wherein, in determining the reference wheel acceleration, at least one of the accelerations and a yaw rate are determined via a plurality of inertial sensors of the vehicle.

4. The method of claim 1, wherein, in determining the reference wheel acceleration, at least one of the accelerations and a yaw rate are determined via an inertial sensor unit.

5. The method of claim 3, wherein, in determining the reference wheel acceleration, at least one of distances of the wheel from the plurality of inertial sensors and distances from a center of gravity of the vehicle are taken into account.

6. The method of claim 4, wherein at least one of a longitudinal acceleration and a lateral acceleration of the wheel are determined from measured values in a gravity-compensated manner.

7. The method of claim 4, wherein at least one of a longitudinal acceleration and a lateral acceleration of the wheel are determined from measured values in a gravity-compensated manner by at least one of:
projection onto a driving plane; and,
calculation and subtraction of vertical acceleration values.

8. The method of claim 1, wherein, in determining the reference wheel acceleration, the accelerations and the yaw behavior of the vehicle in a driving plane of the vehicle are determined without accelerations or rotations in the direction perpendicular to the driving plane.

9. The method of claim 1, wherein, in determining the reference wheel acceleration of the vehicle, a longitudinal acceleration and a lateral acceleration of the wheel are determined in a vehicle coordinate system.

10. The method of claim 1, wherein the reference wheel acceleration is determined in whole or in part from position measurements of the vehicle in an external position system.

11. The method of claim 10, wherein the external position system is a global position system.

12. The method of claim 1, wherein, in determining the real wheel acceleration, a longitudinal slip and a transverse slip of the wheel are used or determined.

13. The method of claim 12, wherein the transverse slip is determined using at least one transverse slip input variable including at least one of:
a wheel revolution rate, a wheel speed, a steering angle of the wheel relative to a longitudinal direction of the vehicle, a yaw rate, and a track width of an axle of the vehicle.

14. The method of claim 12, wherein the longitudinal slip is determined by at least one longitudinal slip input variable including at least one of:
a wheel revolution rate of the wheel, a wheel speed of the wheel, a steering angle of the wheel relative to a longitudinal direction of the vehicle, a yaw rate of the vehicle, a track width of an axle of the vehicle, a direction of travel of the vehicle, and a driving speed of the vehicle.

15. The method of claim 13, wherein some or all of the following longitudinal slip input variables and transverse slip input variables are measured and used as current measured values:
the wheel revolution rate, the steering angle, the yaw rate, and the driving speed.

16. The method of claim 1, wherein the reference wheel acceleration and the real wheel acceleration are related to a same coordinate system and transformed into each other.

17. The method of claim 1, wherein the reference wheel acceleration and the real wheel acceleration are related to a same coordinate system and transformed into each other, wherein the real wheel acceleration is first determined in a vehicle-related coordinate system, and the reference wheel acceleration is determined in a wheel-related coordinate system, with subsequent adjustment.

18. The method of claim 1, wherein, in determining the real wheel acceleration, a value normalized by the maximum coefficient of friction is determined; and, in determining the reference acceleration, a value dependent on the maximum coefficient of friction is determined, so that the maximum coefficient of friction is determined from a quotient of the reference acceleration and the real wheel acceleration.

19. The method of claim 1, wherein maximum coefficients of friction are determined for several wheels.

20. The method of claim 19, wherein maximum coefficients of friction are determined for several wheels separately from each other.

21. The method of claim 1, wherein the vehicle has at least two or more axles and maximum coefficients of friction are determined for some or all wheels of non-liftable axles.

22. The method of claim 1, wherein the vehicle has two to five axles and maximum coefficients of friction are determined for some or all wheels of non-liftable axles.

23. The method of claim 1, wherein with a small steering angle below a steering angle limit, a longitudinal slip and a transverse slip are calculated using a projection difference of projections of the longitudinal slip and the transverse slip onto a longitudinal direction of the wheel.

24. The method of claim 1, wherein with non-steered axles or with a steered axle when driving straight ahead, a longitudinal slip and a transverse slip are calculated using a projection difference of projections of the longitudinal slip and the transverse slip onto a longitudinal direction of the wheel.

25. The method of claim 1, wherein an equation is used as a combined wheel slip of wheels of a front axle, wherein the equation is:
$$( GL - sl - komb )$$
$${sl}_{{1}_{jx}} - {sl}_{{1}_{{j}_{y}}} tan {δ}_{{1}_{j}} = \frac{{V}_{{i}_{j}} σ - ( ( {V}_{x} σ - {C}_{1 y} {ω}_{z} ) sec {δ}_{{1}_{j}} )}{max ( \vert \text{?} \vert , \vert ( \text{?} - {C}_{1 y} {ω}_{z} ) sec {δ}_{{1}_{j}} + \text{?} tan {δ}_{{1}_{j}} \vert )}$$
$$\text{?} \text{indicates text missing or illegible when filed}$$
with
sl₁ⱼₓ being wheel slip in the x direction, longitudinal slip,
sl_{1jy} being wheel slip in the y direction, transverse slip,
δ₁ⱼ being a steering angle of the wheel,
vx being a driving speed in the x direction (longitudinal direction),
v₁ⱼ being a wheel speed,
σ being a direction of travel of the vehicle, with σ=1 for forward travel, σ=0 for standstill and a=−1 for reverse,
ω_{z} being the yaw rate, that is, rotation rate around vertical axis z, and,
C_{1y} being a tire constant depending on geometric position.

26. A vehicle control method comprising:
determining at least one maximum coefficient of friction, wherein said determining the at least one maximum coefficient of friction includes determining a reference wheel acceleration of a wheel, wherein accelerations and a yaw behavior of at least one of the vehicle and the wheel on a road are determined;
wherein said determining at least one maximum coefficient of friction further includes determining a real wheel acceleration of the wheel, wherein a slip behavior of the wheel on a road surface is determined;
wherein said determining at least one maximum coefficient of friction further includes comparing the reference wheel acceleration and the real wheel acceleration, wherein the maximum coefficient of friction is determined from said comparing the reference wheel acceleration and the real wheel acceleration; and,
controlling or regulating a driving behavior of the vehicle on a basis of the at least one determined maximum coefficient of friction.

27. The vehicle control method of claim 26, wherein the driving behavior of the vehicle is controlled or regulated by controlling at least one of vehicle brakes and a drive of the vehicle.

28. The vehicle control method of claim 26, wherein the vehicle control method is performed by at least one of: an anti-lock braking control system, a traction control system, an electronic braking system, a vehicle dynamics control system, a driver assistance system, a driver comfort system, a distance control system, an automatic cruise control, and an electronic stability system.

29. The vehicle control method of claim 26 further comprising determining a current coefficient of friction for individual wheels or all wheels, wherein the driving behavior of the vehicle is controlled or regulated on a further basis of the current coefficient of friction.

30. A vehicle control system configured to perform the method of claim 1 and control or regulate a driving behavior of the vehicle on a basis of the determined maximum coefficient of friction.

31. The vehicle control system of claim 30, wherein the driving behavior of the vehicle is controlled or regulated by controlling at least one of vehicle brakes and a drive of the vehicle.

32. The vehicle control system of claim 30, wherein the vehicle control system is at least one of: an anti-lock braking control system, a traction control system, an electronic braking system, a vehicle dynamics control system, a driver assistance system, a driver comfort system, a distance control system, an automatic cruise control, and an electronic stability system.

33. The vehicle control system of claim 31, wherein the vehicle control system is further configured to determine a current coefficient of friction for individual wheels or all wheels and to control or regulate the driving behavior of the vehicle on a further basis of the current coefficient of friction.

34. A control unit for a vehicle control system of a vehicle, the control unit comprising:
a processor;
a non-transitory computer readable medium having program code for determining a maximum coefficient of friction of a wheel of the vehicle on a road stored thereon;
said program code being configured, when executed by said processor, to:
determine a reference wheel acceleration of the wheel, wherein accelerations and a yaw behavior of at least one of the vehicle and the wheel on the road are determined;
determine a real wheel acceleration of the wheel, wherein a slip behavior of the wheel on a road surface is determined;
compare the reference wheel acceleration and the real wheel acceleration; and,
determine the maximum coefficient of friction from the compared reference wheel acceleration and real wheel acceleration.

35. A vehicle comprising:
a control unit for a vehicle control system of a vehicle;
at least two non-liftable axles;
an inertial sensor unit;
said control unit including a processor and a non-transitory computer readable medium having program code for determining a maximum coefficient of friction of a wheel of the vehicle on a road stored thereon;
said program code being configured, when executed by said processor, to:
determine a reference wheel acceleration of the wheel, wherein accelerations and a yaw behavior of at least one of the vehicle and the wheel on the road are determined;
determine a real wheel acceleration of the wheel, wherein a slip behavior of the wheel on a road surface is determined;
compare the reference wheel acceleration and the real wheel acceleration; and,
determine the maximum coefficient of friction from the compared reference wheel acceleration and real wheel acceleration.

36. The vehicle of claim 35, wherein the vehicle is a commercial vehicle.

37. The vehicle of claim 35, wherein the vehicle has two to five non-liftable axles.
